(19) United States
(12) Patent Application Publication
(10) Pub. No.: US 2014/0132717 A1
(43) Pub. Date: May 15, 2014

(54) METHOD AND SYSTEM FOR DECODING A STEREOSCOPIC VIDEO SIGNAL

(71) Applicant: Matthias Laabs, Munchen (DE)

(72) Inventor: Matthias Laabs, Munchen (DE)

(73) Assignee: INSTITUT FUR RUNDFUNKTECHNIK GMBH, Munchen (DE)

(21) Appl. No.: 14/111,960

(22) PCT Filed: Apr. 19, 2011
(86) PCT No.: PCT/IB11/51698

§ 371 Date: Dec. 16, 2013

(51) Int. Cl. H04N 13/00

(52) U.S. Cl. CPC H04N 13/0048
USPC 348/43

(57) ABSTRACT

A method and a system for decoding a stereoscopic video signal of the type including a sequence of composite frames each including a left image for the left eye and a right image for the right eye are disclosed. The method provides for detecting one or more edges inside at least one of the composite frames; determining a stereoscopic format of the video signal based on the edge detection; and extracting the right image and the left image based on the determined stereoscopic format.

### FIELD OF THE INVENTION

The present invention relates to 3D video processing and particularly relates to a method for decoding a stereoscopic video signal to display a 3D video content. The invention further relates to a system for processing a 3D video by implementing the method above mentioned.

### BACKGROUND OF THE INVENTION

It is known that in order to obtain a 3D effect in images or video contents it is necessary to provide different images to the left and right eye, in particular two different views of the same target (an object or a scene in general).

These two images, usually called Left image and Right image, can be generated electronically by computer graphics, or can be acquired by two cameras placed in different positions and pointing at the same target. Generally, the distance between the two camera lenses is about 6 cm, i.e. similar to the distance between the two human eyes.

By displaying the left and right images at different times or with different polarizations, and by providing the user respectively with shutter glasses or polarized glasses, it is possible to provide each eye with a different view of the same target so, as to reproduce the 3D effect.

A stereoscopic (or 3D) video stream therefore requires two different sequences of images, one for the left eye and one for the right eye. This would require twice the transmission bandwidth of a comparable 2D video product, which creates a big problem for the broadcasters that would like to broadcast stereoscopic video contents.

To overcome this drawback, a solution recently adopted by the Blu-Ray association to reduce the requirement of bandwidth is the so called “2D+delta” solution, wherein the left image is transmitted without decimation (as a 2D image) while the right one is transmitted as a “difference image” with respect to the left image. This solution is also known as MVC (Multi View Coding) and is disclosed in annex H of the ITU H.264 specification. This solution, though, does not provide sufficient bandwidth reduction. In order to better reduce the bandwidth, it is also known to mix the two views in a single frame, also called “composite image” or “composite frame”. Mixing is achieved in different ways by decimating the two original images and by organizing the pixels of the decimated Left and Right images in different ways in the composite image; as an example Left and Right images can be put side-by-side, one above the other (so called “top-bottom” format), or mixing them in a checkerboard or similar manner.

Since there is not a standard method to mix the Left and Right images in a composite frame, different producers produce 3D video contents according to different stereoscopic formats.

In order to correctly reproduce a 3D video stream (received in broadcast or read by a support like a DVD or Bluray disk or a mass memory) the user shall manually select the type of 3D format used for creating the composite image. However, this is a static solution not suitable for use in any situation (e.g. if different 3D video contents with different formats are mixed).

There is also the drawback that at the receiving side, even knowing the stereoscopic format of the video content to be reproduced (e.g. side by side), it is not known which of the two images in the composite frame is the left image and which is the right image; sending the right image to the left eye and the left image to the right eye produces a corrupted 3D presentation of the stereoscopic images, with unpleasant effects for the viewer.

To overcome this last drawback, it is known to embed in the video signal (transmitted or stored) an information pattern indicating the stereoscopic format used for the composite frame and the position of each sub-image in the composite frame.

However, this solution has the drawback of increasing the computational complexity at the transmitting side and of requiring the decoder to be able to extrapolate and correctly interpret the information pattern.

### OBJECTS AND SUMMARY OF THE INVENTION

It is an object of the present invention to overcome the above drawbacks, by providing a method and a system for decoding a stereoscopic video signal that is highly efficient and relatively cost-effective.

It is also an object of the present invention to provide a method and a system for decoding a stereoscopic video signal that works for a plurality of stereoscopic formats, and in particular for those using composite images.

A further object is to provide a method and a system for decoding a stereoscopic video signal that identifies the right image and the left image in a composite frame of a stereoscopic video signal, without the need for an information pattern embedded in the video signal.

These and further objects of the present invention are achieved by a method and a system for decoding a stereoscopic video signal incorporating the features of the annexed claims, which form integral part of the present description.

According to one aspect of the invention, the method comprises a processing step of one or more composite frames of the stereoscopic video stream to determine which stereoscopic format (or mixing method) is used.

This processing step is preferably performed by a mathematical algorithm (like the discrete Laplace operator) that implements a method to find edges inside the composite frame.

Edges in images are areas with strong intensity contrasts. By identifying edges in a composite image, the mathematical algorithm will also find the lines that separate groups of pixels of the two Right and Left images. These lines are typically lines with a strong intensity contrast on their sides.

Preferably, by comparing the detected edges with predetermined edges orientations corresponding to predetermined stereoscopic formats, it is possible to determine the stereoscopic format used for coding the stereoscopic video. As an example, side-by-side format has a vertical edge in the middle of the composite frame, while the top bottom format has an horizontal one.

Preferably, since images can have their own edges independently from the stereoscopic format, the results of the composite frame processing step are compared with statistical data obtained applying the same mathematical algorithm to composite images. In other words, the method can comprise a learning phase (either accomplished during operation or during the design phase of a decoder) wherein a plurality of composite images are processed by the above said mathematical algorithm and wherein for each stereoscopic format it is created a statistic of the found edges, and in particular of the found edges' orientation. During operation, one or more composite frames of the video stream are processed for retrieving edges and the results are compared with these statistics so as to identify the stereoscopic format of the decoded video signal.

In one preferred embodiment, if the video signal is compressed, e.g. with MPEG technology, the composite frames used for identifying the stereoscopic format are selected based on the size of the frame, i.e. expressed in bytes/bits. In this way by selecting only large-bytes frames, it is possible to discard frames like those at the start of a film, which are almost all black and therefore are not useful for identifying the format(if two black images are put one beside the other, there are no edges at all).

The method according to the invention allows an automatic detection of the stereoscopic format of a video stream, it is very simple to implement and does not increase too much the computational complexity at the receiving side, therefore having low implementation costs.

According to another aspect of the invention, the method may comprise a further step wherein calculation of a depth matrix is implemented starting from the two images extracted by the composite image.

According to the invention, the depth matrix is calculated to determine which is the left image and which is the right image. Again, this is made by a statistical analysis. In particular since objects in the foreground have a bigger depth than objects in the background, if the depth matrix presents higher values in the lower portion, this would indicate that it has been calculated using the correct assumptions on which was the left image in the calculation, otherwise this means that the initial assumption was wrong and the real left image is indeed the one considered as right image in the calculation of the depth matrix.

Therefore, advantageously, the method recognizes the right and the left images without adding any information pattern in the video signal. The computational complexity at the transmitting side is therefore lower than the prior art solutions using information patterns.

The method of the present invention can successfully be implemented on available decoding systems, such as commercial set-top-boxes. According to another aspect of the invention, a system implementing the above methods comprises:
at least one first computational unit adapted to process one or more of the composite frames of a stereoscopic video stream with a mathematical algorithm to detect at least one edge inside each of said one or more composite frames so as to determine the format of the stereoscopic video stream;
at least one memory unit to store a first image and a second image of one of said one or more composite frames.

### BRIEF DESCRIPTION OF THE DRAWINGS

Further features and advantages of the invention will be more apparent from the detailed description of a preferred, non-exclusive embodiment of a method and a system for decoding a stereoscopic video signal according to the invention, which are described as non-limiting examples with the aid of the annexed drawings, in which:

FIG. 1 is a bloc diagram of a system according to the invention;

FIG. 2 is a flow chart of a method according to the invention.

These drawings illustrate different aspects and embodiments of the present invention and, where appropriate, like structures, components, materials and/or elements in different figures are indicated by similar reference numbers.

### DETAILED DESCRIPTION OF A PREFERRED EMBODIMENT

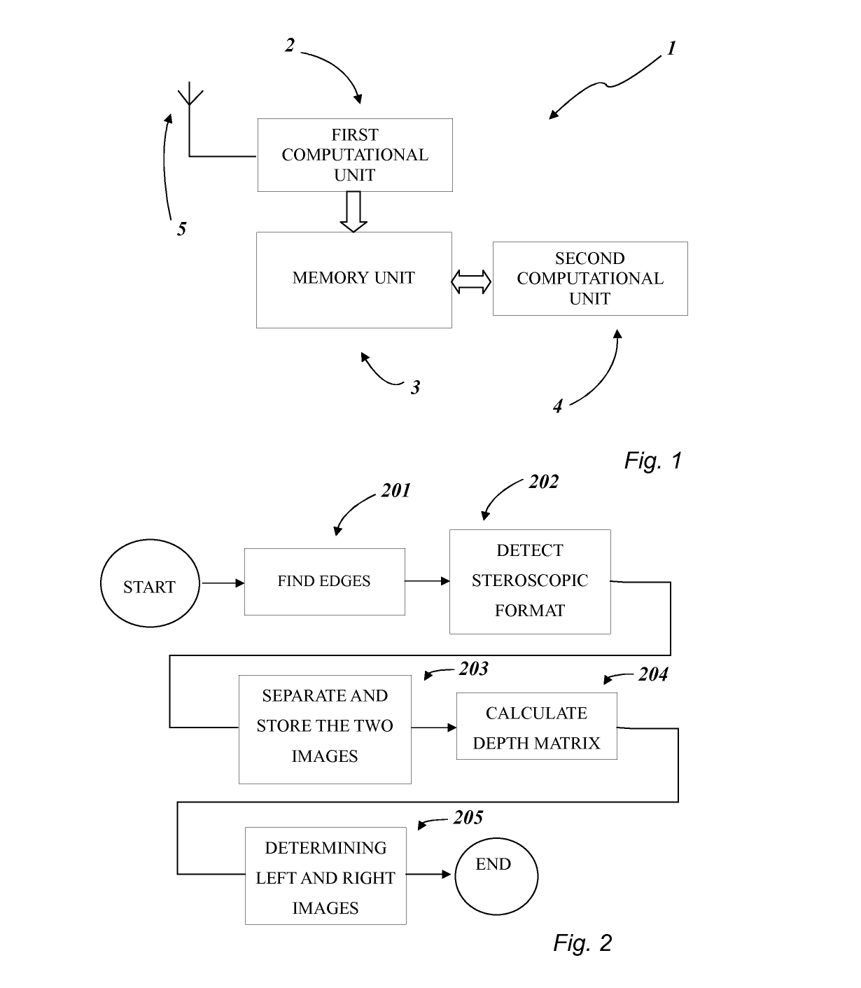

FIG. 1 shows a system for decoding a stereoscopic video signal according to the invention, generally indicated with number 1.

Decoding system 1 is adapted to implement the method of FIG. 2 and to operate with a stereoscopic video signal of the type comprising a sequence of composite frames each comprising a left image for the left eye and a right image for the right eye.

In the embodiment of FIG. 1, decoding system 1 comprises an antenna 5 for receiving video signals, and in particular stereoscopic video signals.

More in general, the decoding system 1 can be any device suitable to receive or read a video frame. As non-limiting example, decoding system 1 can be a set-top box or a TV set provided with a receiver for receiving a video signal from an external device, a reader for an optical support (a DVD or a CD or a BluRay Disk), a device for reading the content of mass memories like USB memory sticks and hard disks, or a device for reading magnetic supports.

According to an aspect of the invention, decoding system 1 comprises a first computational unit 2 adapted to process one or more composite frames of the stereoscopic video signal to determine the stereoscopic format of the video signal, i.e. in which way the left and right image are mixed in the composite frame.

As non-limiting examples, stereoscopic formats may be side-by-side, top-bottom, checkerboard, line alternation, or any other known method. In one embodiment, computational unit 2 analyses (step 201 of FIG. 2) a composite frame of the stereoscopic video signal generally by means of a mathematical algorithm adapted to detect edges inside the composite frame.

Since the right and left images in a composite frame are generally separated by one or more edges depending from (and therefore characteristic of) the stereoscopic format, by detecting the edges inside the composite frame it is possible to determine (step 202) the stereoscopic format of the video signal and to extract (step 203) the left and right images.

Preferably for the processing step 201 computational unit 2 makes use of a mathematical algorithm implementing a method like a gradient method or a Laplacian matrix. An example of algorithm is the Sobel algorithm known for detecting edges in digital images; this algorithm provides for each pixel a value and a direction of the edge, therefore generating as output information (in particular under form of a matrix) representative of the edges' position and orientation.

Since left and right images can have their own edges independently from the stereoscopic format, in a preferred embodiment computational unit 2 implements the composite frame processing step on a plurality of composite frames.

In one embodiment, computational unit 2 creates an edge matrix comprising a number of elements corresponding to the pixels of the composite frame. For each composite frame analysed, if a pixel is part of an edge, the value of the corresponding matrix element is increased of one or more units. In this way after having analysed a plurality of composite frames, the computational unit will be able to determine which are the edges that are present in all (or almost all) the composite frames; this edges are the ones depending on the stereoscopic format and are therefore those significant for determining the stereoscopic format.

In a preferred embodiment, if a pixel is not part of an edge, the value of the corresponding matrix element is reduced of one unit; in this way the computational unit 2 gets faster to the stereoscopic format detection since temporary edges are, in a certain way, smoothed or removed from the edge matrix, thus allowing computational unit 2 to get faster to a decision.

The number of composite frames analysed can be a predetermined number or can depend on the results of the composite frame processing step; in particular, in this latter embodiment, the processing step is carried out until computational unit 2 is in the position of determining with a predetermined degree of certainty (e.g. 90%) the stereoscopic format. This degree of certainty can be calculated by using Bayesian Probabilities for the strengths of the vertical and horizontal centering edges.

Often a video content begins with some black frames with some words, typically the opening credits. These types of frames are not suitable for identifying the stereoscopic video format since the juxtaposition of two black regions pertaining one to the right image and the other to the left image, does not create an edge and often the words are placed in the screen's z-layer. Therefore, in a preferred embodiment the composite frame processing step is applied to selected frames which are known to contain figures or objects.

In compressed digital video streams, identification of these frames is made based on the size of frame. Frames comprising big uniform areas (like the opening black frames) are compressed much more than frames representing a plurality of objects in the image, consequently, in a preferred embodiment, computational unit 2 analyses frames having file dimensions greater than a predetermined threshold.

In one embodiment, the results of the edge detection analysis carried out on the composite frames is compared with data obtained during a learning phase of the computational unit. During this learning phase the same type of edge detection analysis is carried out on a plurality of composite images having different stereoscopic formats. In one embodiment, for each type of stereoscopic format a statistic table is generated which gives an indication of edge distribution inside the composite frame; in this way during operation it is possible to identify the stereoscopic format of a video stream by applying the same edge detection analysis to one or more composite frames and by comparing the results with the statistic data. Comparison can be made, e.g., by projecting the vector of the edge detection analysis result, made on the analysed video stream, on the spaces of the edge detection analysis results constructed during the learning phase for the different stereoscopic formats and by calculating the projection error. If the projection error for a given space is below a predetermined threshold, the stereoscopic format of the video stream is determined to be the stereoscopic format associated to that space.

Having identified the stereoscopic format, it is possible to identify the two images composing thereof and, consequently, to extract the left and right images (step 203). According to another aspect of the invention, system 1 comprises a memory unit 3 able to store the two images identified with the process above described.

Up to this step, the method is per se not able to know which of the two images is the left image and which the right image; decoding system therefore can be set to decide which is the left image based on the stereoscopic format, e.g. if the format is a top bottom, decoding system can be set to decide that the top image is the left one; if the format is a side by side, the decoding system can be set to decide that the image on the left half of the composite frame is the left one.

In one embodiment (step 204 of FIG. 2), the system 1 is adapted to detect which is the left image and which is the right image within a composite frame. To this purpose, decoding system 1 comprises also a second computational unit 4 designed to calculate a depth matrix (step 204) indicating the depth of objects within a scene corresponding to a composite frame.

Algorithms for calculating a depth matrix (or disparity matrix as it is sometime called) are per se known, and therefore are not discussed in detail in this description. As an example, an algorithm for calculating a depth matrix is provided by MathWorks®. These algorithms require as input a right image and a left image.

Since in an image foreground, objects appear to have a bigger depth than background objects, if depth matrix has been calculated correctly using as right image the real right image, then the depth matrix is expected to present higher values in the lower half. By checking the position of the higher depth values in the depth matrix, it is therefore possible to identify (step 205) which is the right image and which the left image in the composite frame.

The depth matrix can be calculated using full left and right images, but this requires a huge computational complexity.

For this reason, in one embodiment the depth matrix is calculated only for a reduced portion of composite frame, therefore using only corresponding portions of the left and right image. Generally, each of these corresponding portions comprises at least one group of contiguous pixels of the respective image. Moreover, each group of contiguous pixels is composed by pixels comprised in a rectangle having one side long N pixels and the other side long M pixels.

Preferably the groups of pixels considered are square, i.e. N=M, and their dimensions are strictly correlated to the elementary unit considered for the compression.

For example in the MPEG H.264 coding, the elementary unit considered for compression is a block of 8×8 pixels used for the chrominance matrixes, therefore N=8. In one embodiment, if the video stream is an MPEG compressed video stream of the type transporting composite frames (therefore not compressed according to MVC), the processing steps (201-205) implemented by decoding system 1 are carried out only on some frames, in particular only I frames.

If the left and right border of the image contains any relevant depth-clues, i.e., edges, those parts of the image are preferable for detecting the left and right image. It is common practice to have no objects coming out of the screen at the vertical borders, as they would otherwise be cut by the frame of the video, which is behind the object and thus the 3D illusion would be broken. Therefore objects in these areas should be all on or behind the screen layer. If it is the other way around, left and right image are swapped.

According to another aspect of the invention, the first computational unit 2 and the second computational unit 4 may be made by a single CPU or similar.

Operatively, when the decoding system 1 receives or reads a stereoscopic video signal, the first computational unit 2 of system 1 of the invention starts processing one or more of the received composite frames to determine the stereoscopic format.

At the end of this analysis, the system 1 knows the stereoscopic format and (in a preferred embodiment) detects which of the two images present in the composite frame is the left image and which is the right image.

The first computational unit 2 separates the two sub-images of each composite frame and stores them in a memory unit.

In the next step, the second computational unit 4 takes from the memory unit 3 a pair of images extracted from the same composite frame and calculates a depth matrix.

By analyzing the distribution of depth values in the depth matrix, the second computational unit 4 determines which is the left view and which is the right view identifying if foreground objects are in the lower or higher half of the matrix.

The above disclosure shows that the invention fulfils the intended objects and, particularly, overcomes some drawbacks of the prior art.

The method and the system described are highly efficient and relatively cost-effectives. The method described above and the system that implements the method allows an automatic decoding of a stereoscopic video stream without intervention of the user and without requiring information pattern to be embedded within the stereoscopic video signal.

The method of the present invention can be advantageously implemented through a program for computer comprising program coding means for the implementation of one or more steps of the method, when this program is running on a computer. Therefore, it is understood that the scope of protection is extended to such a program for computer and in addition to a computer readable means having a recorded message therein, said computer readable means comprising program coding means for the implementation of one or more steps of the method, when this program is run on a computer.

The system and the method according to the invention are susceptible of a number of changes and variants, within the inventive concept as defined by the appended claims. All the details can be replaced by other technically equivalent parts without departing from the scope of the present invention.

While the system and the method have been described with particular reference to the accompanying figures, the numerals referred to in the disclosure and claims are only used for the sake of a better intelligibility of the invention and shall not be intended to limit the claimed scope in any manner.

Further implementation details will not be described, as the man skilled in the art is able to carry out the invention starting from the teaching of the above description.

1. Method for decoding a stereoscopic video signal of the type comprising a sequence of composite frames, each frame comprising a left image for the left eye and a right image for the right eye, wherein said method comprises the following steps:
detecting one or more edges inside at least one of said composite frames;
determining a stereoscopic format of said video signal based on said edge detection;
extracting the right image and the left image based on the determined stereoscopic format;
wherein said extracting step comprises the following steps:
identifying two images contained in each of said composite frames based on said determined stereoscopic format;
calculating a depth matrix of said two images;
determining which of said two images is said right image and which of said two images is the left image, by identifying, basing on said depth matrix, the location of foreground objects within the composite image.

2. Method according to claim 1, wherein said detecting step is performed by processing said at least one of said composite frames by a mathematical algorithm implementing a method to find edges of images.

3. Method according to claim 2, wherein said determining step is performed comparing the detected edges with predetermined edge orientations' information, corresponding to predetermined stereoscopic formats of composite frames.

4. Method according to claim 3, wherein said predetermined edge orientations' information is comprised in statistical data of the edges, said statistical data being obtained by applying said mathematical algorithm to predetermined composite frames corresponding to different stereoscopic formats.

5. Method according to claim 4, further comprising a learning phase wherein a plurality of composite frames are processed by said mathematical algorithm to create, for each stereoscopic formats, said statistical data of the edges.

6. Method according to claim 1, wherein said right image and left image have size greater than a predetermined threshold.

7. Method according to claim 1, wherein said calculating step is performed on at least one portion of a first image of said two images and on at least one corresponding portion of a second image of said two images.

8. Method according to claim 7, wherein said portions of first and second image are a left and a right border of the image.

9. Method according to claim 7, wherein said image portions comprise pixels of a rectangle, having sizes of N pixels and M pixels respectively.

10. Method according to claim 9, wherein N=M.

11. Method according to claim 1, wherein said composite frames are obtained by combining said right image with said left image, according to a method chosen in the group comprising: the side by side method, the top-bottom method, the checkerboard method.

12. System for decoding a stereoscopic video signal of the type comprising a stream of composite frames, each frame comprising a left image for the left eye and a right image for the right eye, said system being configured to comprise means for the implementation of the method according to claim 1.

13. System according to claim 12, comprising:
at least one first computational unit adapted to process one or more of said composite frames to detect at least one edge inside each of said one or more of said composite frames so as to determine the format of the stereoscopic video signal;
at least one memory unit to store a first image and a second image of one of said one or more composite frames.

14. System according to claim 13, comprising at least one second computational unit adapted to calculate a depth matrix on at least one portion of said first image and on at least one corresponding portion of said second image of said two images, in order to determine which one of said first image and said second image is said left image and which one is said right image.

15. System according to claim 14, wherein said first computational unit and said second computational unit are comprised in a single processing unit.

16. Computer program comprising computer program code means adapted to perform all the steps of the method of claim 1, when said program is run on a computer.

17. A computer readable medium having a program recorded thereon, said computer readable medium comprising computer program code means adapted to perform all the steps of the method of claim 1, when said program is run on a computer.
